(19) United States
(12) Patent Application Publication
(10) Pub. No.: US 2021/0315215 A1
(43) Pub. Date: Oct. 14, 2021

(54) Non-Toxic Larvicide Using Fennel Oil As Active

(71) Applicant: Unm Rainforest Innovations, Albuquerque, NM (US)

(72) Inventors: Ivy Hurwitz, Albuquerque, NM (US); Alexandra Yingling, Rancho Santa Margarita, CA (US)

(21) Appl. No.: 17/224,611

(22) Filed: Apr. 7, 2021

Related U.S. Application Data
(60) Provisional application No. 63/007,602, filed on Apr. 9, 2020.

(51) Int. Cl. A01N 65/10; A01N 25/28; A01N 25/00; A01N 25/24

(52) U.S. Cl. CPC A01N 65/10; A01N 25/24; A01N 25/006; A01N 25/28

(57) ABSTRACT

Fennel oil or its principle component, trans-anethole, is encapsulated into non-viable yeast cells for larvicide application. Mosquito larvae are especially sensitive to this larvicide, even more so than previously described yeast-encapsulated essential oils. The larvicide is cost-effective and non-toxic to humans throughout manufacturing, storage, and application.

### RELATED APPLICATIONS

This application claims the benefit of priority of U.S. provisional application Ser. No. 63/007,602, filed Apr. 9, 2020, the entire contents of which application is incorporated by reference herein.

### BACKGROUND OF THE INVENTION

Various insects are known carriers for pathogens of human and/or non-human disease and/or are linked to the destruction of crops and/or other undesired outcomes. Thus, significant resources are devoted to limiting and/or controlling various “pest” insect populations. For example, mosquitos are known carriers for pathogens of diseases including, but not limited to, malaria (Anopheles) Zika virus, dengue virus, yellow fever, (Aedes) and West Nile virus (Culex). Accordingly, it is very desirable to kill pest insects like mosquitos at the larval stage, before they can spread disease and infection.

Unfortunately, the most commonly used method for limiting and/or controlling undesirable insect populations are pesticides which are often harmful to humans and other non-target species. In the case of mosquitos and other water born pests, many communities resort to adding synthetic pesticides to water reservoirs, including sources of potable water, for mosquito control. The synthetic pesticides used are neurotoxins and growth inhibitors. Their dispersal in the water supply poses a risk to these communities. Furthermore, the manufacture, storage and transport of chemical pesticides all present potential hazards to humans, animals, and/or other non-target species.

Other methods for controlling insect populations, such as the engineering of genetically modified insects are expensive and currently available in only limited areas and only for a specific variety of mosquito (Aedes). Furthermore, because it is not always possible to control the movement or migration of an insect population, genetic modification may not be a viable mechanism for populations that are considered pests in a particular region, but which are benign or even beneficial in other regions. Furthermore, because this technology is new and largely untested, it's difficult to predict the long-term consequences and efficacy of releasing genetically modified populations of mosquitos.

Accordingly, novel methods of controlling pest insect populations that are non-toxic to humans, animals, and/or desirable insect populations are thus desirable. However, while non-toxic (to humans and other animals) substances such as essential oils have been shown to be effective in killing insect larvae, deployment of essential oils to pest populations is problematic, as large amounts of essential oil would have to be repeatedly added to oviposition sites to achieve significant reduction in the pest population. Furthermore, the dispersed oils would then be vulnerable to degradation by UV radiation and would disrupt the aquatic environment, with the potential for adverse effects on non-target species. Accordingly, an effective mechanism for delivering substances like essential oils directly to the pest larvae population is greatly desired.

The need for vector control measures is particularly common in rural and poor communities. As such, successful vector control methods are simple, low cost solutions that are easy to deploy.

### BRIEF DESCRIPTION OF THE INVENTION

The present disclosure provides a novel larvicide that is low cost and non-toxic to humans during manufacture, storage, and application. The larvicide is based upon fennel oil as active agent. Yeast-encapsulated fennel oil has more potency against mosquito larvae than other essential oils that have been encapsulated into yeast for larvicidal purposes. All larvicide manufacturing products and by-products are generally regarded as safe. Formulation and application methods for the novel larvicide are included in the present disclosure.

### BRIEF DESCRIPTION OF THE DRAWINGS

FIG. 1 shows the principal larvicide component of fennel oil, trans-anethole which comprises 95%+, often 99%+, of the active larvicide component of fennel oil.

FIG. 2 shows the dose-response of Aedes aegypti larvae to fennel oil after 24 hour exposure. The steepness of the slope shows that the larvae are sensitive to the fennel oil, which makes fennel oil ideal for larval source management. This FIGURE shows the rate of mortality of L3 Aedes aegypti larvae when exposed to varying concentrations of fennel oil. Each point represents a single test of 4 cups of 25 larvae. All tests were performed in triplicate on different days.

FIG. 3 shows a comparison study of the efficacy of fennel oil and orange oil on A. aegypti L3 larvae. Shown is a plot which compares the efficacy of fennel oil and orange oil on Aedes L3 larvae. Each point represents a single test of 4 cups of 25 larvae. Note that fennel oil was unexpectedly and substantially more effective against Aedes L3 larvae than was the orange oil.

### DETAILED DESCRIPTION

The present disclosure provides an inexpensive novel insect larvicide capsule based upon fennel oil (FO), and in particular trans-anethole, the principal active larvicide in FO. The components and byproducts of this larvicide are generally regarded as safe. As such, it is non-toxic to humans throughout the duration of the product lifecycle. The present disclosure includes synthesis and application methods for the novel larvicide.

The target species is identified as the selected target of the larvicide for the purposes of the present disclosure. While many of the specific embodiments provided herein refer to Aedes larvae as the intended target, it will be understood that mosquito larvae of other species (Anopheles or Culex) may also be the intended target and that the larvicide may be altered, as described herein, to be more particularly suited towards one target or another. Furthermore, it will be understood that the novel larvicide described herein may be designed to be suitable for more than one target and that references to “a” or “the” target species does not necessarily preclude embodiments wherein there is more than one target species.

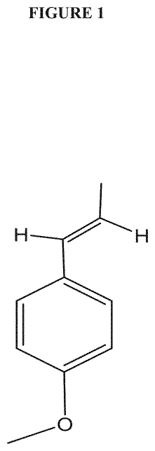

According to various embodiments, the novel larvicide capsule comprises a larvicidal element encapsulated in an ingestible delivery vehicle. According to various embodiments, the larvicidal element is a substance that is non-toxic to humans, but which negatively impacts the ability of the target species to behave in an undesirable manner. For example, ingestion of the larvicidal element by the target may result in the immediate or eventual death of the target. Alternatively, ingestion of the larvicidal element by target may result in the larvae being unable to transmit a disease vector, sterile, or developmentally hindered in some other way. According to a specific embodiment, the larvicidal element is an essential oil, FO, and in particular, trans-anethole, which is the principal active larvicidal agent in FO, comprising at least 95% of the FO and often 99% or more of the FO. See FIG. 1, hereof.

It has been discovered pursuant to the present invention that the weight ratio of yeast:FO:water in larvicidal compositions according to the present invention range from 2.66 to 4 (yeast):1 (FO):10 to 14 (water) with a particularly optimized ratio being 3.333:1:11. Outside of the broader range 2.66 to 4 (yeast):1 (FO):10:14 (water), the encapsulation efficiency of the FO in yeast drops. The aforementioned preferred ratio is used in an effort to minimize costs and resources while still maintaining excellent larvicidal activity.

FO is an accessible essential oil that is non-toxic to humans. The essential oil of fennel is obtained through the steam distillation of crushed fennel seeds, an herb which bears the genus species nomenclature Foeniculum vulgare. Fennel seeds have been in use in culinary applications since ancient times. They are also widely used for medicinal purposes. These medicinal properties come from the various components of the FO, including alpha-pinene, anisic aldehyde, cineole, fenchone, limonene, myrcene, methyl chavicol, and trans-anethole.

As previously noted, the primary component of FO is trans-anethole, which is produced by plants to provide protection from larvae and adult insects, while remaining non-toxic to humans. This makes it ideal for encapsulation into yeast as a larval source management approach. Additionally, the chemical constituents of FO are unlike other oils that have been previously encapsulated for larvicidal purposes. Trans-anethole is a methoxy derivative of the aromatic compound of phenylpropene (See FIG. 1). The inclusion of the methoxy group on the aromatic ring is a key difference between the FO and previous oils, which have typically included monoterpenes.

For the purposes of the present disclosure, essential oils are defined as terpene containing oils produced by plants. For more than three decades, essential oils have been recognized as cheap, effective larvicides. Essential oils are thought to exert larvicidal effects through three different mechanisms: neurotoxicity, growth inhibition, and interruption of metabolic pathways. The simultaneous action of these mechanisms retards the evolution of resistance to the larvicide. Examples of essential oils that are suitable for use as larvicidal elements include, but are not necessarily limited to, clove bud oil (CBO), mandarin orange oil (MO), sweet orange oil (OO), basil, peppermint, lavender, neem oils and combinations thereof. One or more of these essential oils may be mixed with trans-anethole at a ratio of about 0.5% to about 50% by weight. It is an embodiment that larvicide compositions comprise trans-anethole as the sole larvicidal agent. Since the composition of essential oils may vary, oils may be combined to enhance larvicidal efficacy where the environment or larval physiology provide opportunity. Suitable essential oils can be purchased commercially at low cost or extracted from the plants from which they are derived using standard techniques.

Previous larvicidal compositions have included emulsions formed from mixing an essential oil within a solvent and directly distributing the emulsion to a water source. These larvicidal compositions' mechanism for action was via contact killing. For example, the oils would coat the larvae and interfere with breathing, movement, or their ability to obtain oxygen. However, these oils are also then free to act on the environment and non-target species, being less than optimally useful. According to one embodiment, the ingestible delivery vehicle of the present disclosure is designed to encapsulate the larvicidal element so that the larvicidal element is sequestered or segregated from the environment. That is, the composition contains no appreciable larvicide (i.e., an amount of larvicide which is easily identified), and which has an interaction with the environment with larvicide on the surface of the surface of the larvicidal element, even though the larvicidal element also contains substantial encapsulated larvicide.

For the purposes of the present disclosure the term “ingestible delivery vehicle” is intended to mean an entity capable of encapsulating the larvicidal element and generally sequestering/isolating it from the environment until the delivery vehicle is ingested by the target species. The ingestible delivery vehicle of the present invention is generally non-toxic to non-target species. In general, the ingestible delivery vehicle should be attractive as a food source to the target species and have sufficient durability in the environment in which it will encounter the target species that it can withstand the conditions long enough to be ingested by the target species. For example, many larvae are water-borne and/or find nutrients in aquatic environments thus, in these circumstances the ingestible delivery vehicle should not readily degrade in an aquatic environment.

According to some embodiments, the ingestible delivery vehicle may be inert to all or most environments that do not replicate the environmental conditions found in the digestive system of the target species. Accordingly, to various embodiments, the ingestible delivery vehicle may be an inactive or non-viable yeast cell. According to a more specific embodiment, the ingestible delivery vehicle is a non-viable yeast cell of the S. cerevisae variety. It is a well-documented feature of larval biology that mosquito larvae will readily digest S. cerevisae. In fact, a recommended food for rearing larvae in laboratory settings is S. cerevisae. Moreover, the cell membrane of yeast cells is rich in beta-1,3-glucan, a polysaccharide, and chitin. Larvae have intestinal enzymes specialized for the digestion of beta-1,3-glucan to obtain chitin and beta glucans and are able to rapidly break down ingested yeast cell membranes. Other suitable ingestible delivery vehicles may include (1) S. cerevisae genetically modified for greater essential oil loading and a thicker cell membrane and (2) S. cerevisae opsonized with fragments of adult insect exoskeleton, bacteria, corn oil, corn sugar, and other phagostimulant elements of the larval diet.

The larvicidal element may be encapsulated, infused, injected, entrapped, loaded, etc. (referred to herein collectively as “encapsulated” for ease of discussion) into the ingestible delivery vehicle using any suitable method depending on the specific larvicidal element and ingestible delivery vehicle being used. Examples of suitable methods for encapsulating the larvicidal element in the ingestible delivery vehicle include, but are not limited to, a combination of heat and agitation, plasmolyzation, and coacervation.

According to a specific embodiment wherein a larvicidal capsule comprises an essential oil such as FO as the larvicidal element and a yeast cell such as an S. cerevisae cell as the ingestible delivery vehicle, the FO can be encapsulated within the yeast cell via a process using heat and agitation, as described in greater detail in the Examples section below. The heat and agitation method result in the encapsulation of all components of the essential oils without discrimination, including terpenes and aldehydes. However, molecules as large as 400,000 can freely diffuse through the cell wall.

According to a more specific embodiment, encapsulation may start with 20 wt % (e.g. a range of about 10-30 wt %) yeast cells in distilled water. Essential oil equivalent to the total yeast cell volume is added to the cell solution and shaken for 20-24 hours at 40° C. in either a sealed vial or baffled flask, depending on total volume. The solution is removed from the incubator and spun down.

As explained in greater detail below, ensuring complete removal of any residual oil (i.e. larvicidal element) can be highly desirable for specific embodiments, for example, when the presence of the larvicidal element would be harmful to non-target species. Accordingly, in one embodiment, the present disclosure provides a surfactant-based washing step which ensures complete removal of residual oil from the cell surface. The supernatant is decanted, and a surfactant solution is added to wash oil from the exterior of the cells, with careful attention paid to the concentration to minimize the amount of essential oil extracted from within the cells. The surfactant/cell mixture is well mixed then spun down and decanted again.

Suitable surfactants include, for example, Tween 20, Tween 80, Triton X-100 and sodium dodecyl sulfate (SDS) at concentrations ranging from 10-30%. Surfactants are amphipathic compounds with hydrophilic and hydrophobic portions that will locate themselves at the interface between the fluid phase with different degrees of polarity, such as oil and water. In this manner, the excess EOs are removed from the surface of the cells.

After the surfactant-based washing step, the cells can be washed with water to remove any residual surfactant. After the last wash, the water is decanted, and a small volume of water is added to make the cells fluid for transfer to a lyophilizer jar. The cells are lyophilized at P<0.1 mbar for 16-20 hours. The resulting dried solid is stored into an air-tight container at 4° C.

The process described above uses an excess of oil to ensure maximum encapsulation yield. In practice, and as demonstrated in the Experimental section below, the optimal amount of oil used may differ for different essential oils. It should be noted that optimal EO loading may depend on the intended use. For example, for water-based larvicides, it is desirable to maximize EO loading while maintaining water solubility.

HPLC analysis of larvicides formed using the method above demonstrated up to ˜11% loading by weight for CBO-loaded yeast cells and between 30-40% loading by weight for MO- and OO-loaded yeast cells. Similarly to OO, encapsulation of FO yielded 30-40% loading by weight.

Once the essential oil enters the cell, the yeast becomes nonviable and cannot replicate, thereby reducing or eliminating any potential impact on the environment during storage, transportation, and/or use. However, while the yeast cell is nonviable, the cell's thick outer membrane remains intact and thus sequesters the oil from the surrounding environment. As previously discussed, mosquito larvae have specific intestinal enzymes for the digestion of the beta-1,3-glucans found in the yeast cell wall. This results in a system wherein the FO/yeast cell capsule is essentially inert to all environments it is likely to encounter other than the specialized digestive systems of the target mosquito larvae. Furthermore, it should be noted that both yeast and many essential oils are commonly found in food and are non-toxic to humans.

One of the difficulties in producing effective pesticides is ensuring that the pesticide targets only the desired pest and does not negatively impact unintentional targets or the environment. For example, while cinnamon oil has been demonstrated to be effective at killing mosquito larvae, it is also considered hazardous to the environment. Moreover, the presence of oil itself can be hazardous to the environment. For example, oil can coat the surface of bodies of water acting as a physical barrier and/or contact agent to kill indiscriminately. Even trace residual oil found on the exterior surface of a microcapsule can negatively impact the environment and unintended targets. Furthermore, some essential oils include elements or properties which may act as repellants or deter mosquitos from laying eggs in areas around the pesticides.

Accordingly, it may be desirable to ensure that the microcapsule does not present any residual surface oil and is isolated from the residual surface oil so that the only mechanism for exposure to the encapsulated oil is ingestion of the microcapsule. Accordingly, the present disclosure has provided a surfactant-based washing step which ensures removal of all residual oil from the surface of the microcapsule. It should be noted that inclusion of this washing step may enable the use of oils in combination with FO that have previously been considered unusable as pesticides, like citronella, due to their repellant characteristics.

As another example, it may be desirable to kill Culex larvae but not Aedes larvae. Previous trials have demonstrated that CBO, cinnamon leaf oil, Australian white cypress oil, thyme oil and lemongrass oil are all effective at killing both Aedes and Culex larvae. However, multiple trials utilizing the above-identified essential oils encapsulated and washed using the surfactant-based washing step described above were shown to be ineffective against Aedes larvae at concentrations of up to 250 mg/L encapsulated cells (30-75 mg/L EO, depending on encapsulation efficiency) demonstrating that the encapsulation and washing method effectively sequesters the oils inside the yeast cells.

Moreover, while encapsulated CBO was ineffective against Aedes larvae, the formulation was quite effective against Culex larvae. Accordingly, combinations of FO and CBO may be useful and quite effective against Aedes larvae and Culex larvae. In contrast, MO and OO encapsulated yeast microparticles successfully killed A. aegypti larvae in a dose dependent manner. Accordingly, specific EOs that have been encapsulated in a way that ensures no residual oil is present on the surface of the microparticles enables specific targeting of different species.

Moreover, while much of the present disclosures has been directed towards the use of essential oils, and in particular fennel oil, as the larvicidal element, similar dose-dependent killing was observed with encapsulated R-limonene, γ-terpinene, and myrcene, the primary compounds of MO and OO. For the purposes of the present disclosure, the term “primary compound” is intended to mean the chemical constituents for each of the selected EOs at 5% or greater. Accordingly, the present disclosure includes the encapsulation of one or more essential oil primary compounds including, but not limited to, trans-anethole, or a mixture of trans-anethole and R-limonene, γ-terpinene, and myrcene.

The larvicidal capsules of the present disclosure could be distributed via direct application of the rehydrated larvicide at mosquito nesting sites. The larvae then consume the larvicidal capsules and the yeast cell wall is broken down by enzymes in the gut of 3^{rd} larval instars, which liberates the essential oil(s) from the capsule, allowing the oil to act on the larvae, resulting in larval death. In general, this system could be used in additional to or instead of existing municipal or rural larvicide/insecticide/other pest control programs. Furthermore, because the presently described system can be used in environments where traditional chemical larvicides and insecticides aren't used due to safety risks, the presently described larvicidal system can be used in high value breeding sites, including in drinking water reservoirs and the like.

According to a specific embodiment of use, the larvicidal capsules of the present disclosure could be distributed via (1) an air-water displacement propulsion device to oviposition sites or (2) an auto-dissemination strategy using a cornstarch-based powdered distributed at nesting sites. As above, the larvae consume the larvicidal capsules and the yeast cell wall is broken down by enzymes in the gut the larvee liberating the essential oil(s) from the capsule, resulting in larval death. In general, this system could be used in addition to or instead of existing municipal or rural larvicide/insecticide/other pest control programs. Furthermore, because the presently described system can be used in environments where traditional chemical larvicides and insecticides aren't used due to safety risks, the presently described larvicidal system can be used in high value breeding sites, including in drinking water reservoirs and the like. Alternatively, as described in greater detail below, the larvicidal capsule may be designed to piggyback on female mosquitos, who then carry the capsules back to oviposition sites.

Accordingly, the present disclosure provides methods for delivering or directing the larvicide towards or retaining the larvicide in specific desired environments. For example, because the larvicide targets larvae, it may be desirable to direct and maintain the larvicide to oviposition environments so as to ensure the larvae will have the opportunity to encounter and ingest the larvicide. According to some embodiments, this may involve modifying the larvicidal capsule.

For example, as stated above, the larvicidal capsule may be incorporated in a powder to piggyback on female mosquitos, which can then carry the capsules to known or unknown oviposition sites. For example, the A. Aegypti mosquito tends to rest in dry, sheltered areas such as residential awnings and holes in trees, but also tend to visit many oviposition sites. Accordingly, rather than trying to place the larvicide at each oviposition site, it may be easier to place the larvicide in known resting sites or areas that look like likely resting sites. The larvicidal capsules of the present disclosure may be coated with silica, cornstarch or another pH ˜7 soluble coating to produce a powder which can be spread at likely resting sites and which can then be picked up and delivered to oviposition sites by female mosquitos. Moreover, anatomical difference between male and gravid female mosquitoes could be exploited to improve targeting and transfer of the larvicide to the oviposition sites. For example, the soluble coating may be able to accommodate biofunctionalization for tuning adherence to and aquatic release from female mosquitoes. Soluble coatings may provide other advantages including increasing the effective lifespan of the larvicide and or increasing the speed and efficacy of distribution.

As another example of possible larvicidal capsule modifications, the larvicidal capsules of the present disclosure may be modified to achieve certain desired buoyancies. For example, mosquito larvae are known to have different feeding behaviors, i.e. some are surface feeders while others are benthic (bottom) feeders. In order to ensure that the larvicide reaches the different feeding populations, the present disclosure provides methods for producing capsules with different buoyancies, allowing the capsules to maintain different water levels, or to maintain the location of the capsules in, for example, moving or running water bodies.

According to an embodiment, the buoyancy of the capsule can be altered by introducing air pockets in the capsule. For example, when the ingestible delivery vehicle is a non-viable yeast cell, air pockets could be introduced into the yeast membranes during the encapsulation stage via oxygen infusion. In general, by controlling the volume of the air pocket in relationship to the density of the contents of the capsule, one can control the degree of buoyancy of the capsule, thereby producing a capsule that would float on the surface of the water or maintain a certain water depth.

Alternatively, or additionally, the buoyancy of the capsule can be altered by applying an adhesive element to the exterior of the ingestible delivery vehicle. The presence of an adhesive element promotes clumping and facilitates sinking of the capsules. Suitable adhesive elements may take the form, for example of muco-adhesive compounds such as doped alginates. These could be applied to the exterior of the capsules by painting, dipping, spraying, and immersion/vacuum drying.

Combinations of air pockets and adhesive elements could be used to even more precisely fine tune the capsule so that it can maintain a desired position within the water column. Additionally, buoyancy of the capsule may be altered by altering its essential oil loading capacity, e.g. through the use of plasmolyzers.

Alternative or additional modifications of the capsules include opsonization with phagostimulants, membrane saturation with chemoattractants, and combination in biodynamic configurations to facilitate larval feeding dynamics.

The terms and expressions that have been employed to describe the present invention are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### EXAMPLES

I. Encapsulation of fennel oil in S. cerevisiae

The encapsulation of FO into yeast has been optimized with the ratio of 3.33:1:11 by weight of S. cerevisiae, FO, and water. The components are combined in a baffled flask (Mixture 1).

Mixture 1 is added to a baffled flask and agitated overnight at 40° C.

Mixture 1 is centrifuged for 10 minutes at 2000xg, and the supernatant disposed.

Mixture 1 is washed with 1.25% TWEEN 20, followed by three water rinses to remove excess TWEEN 20. The larvicide is centrifuged after each wash.

The resulting larvicide is diluted to 80 wt. % and aliquoted into tubes. The tubes are frozen and lyophilized for 48 h. Rehydrated larvicide is used for application.

Similar methods of encapsulation can be optimized for essential oils comprising a mixture of FO and at least one additional essential oil.

II. Efficacy of essential oil larvicide

Protocol

Third instar larvae are collected following a starvation period.

Experimental and control groups (25 larvae per group) are allowed to accommodate to 100 ml distilled water in plastic cups for 1 hour.

Experimental group is fed various concentrations of yeast encapsulated essential oil, four replicates per concentration.

Test containers are maintained at 25-28° C., with 12/12 light/dark environment preferred.

Live and dead larvae are counted after 24 and 48 hours with no additional nutrition.

Determination of 50% and 90% mortality and inhibition of adult emergence concentrations.

Abbott's test: control vs. experimental mortality

III. Characterization of Encapsulated essential oils

The extraction of essential oil from yeast is conducted as described in US Patent Publication No. US2020/0015477. Briefly, glass beads and ethanol are added to a tube of larvicide. The mixture is then vortexed on maximum speed, centrifuged, and the ethanol supernatant is collected. This is step is repeated again. This bead milling process collects approximately 90% of the encapsulated oil.

Quantitative analysis by HPLC is performed as provided for in US Patent Publication No. US2020/0015477, which is incorporated by reference in its entirety herein. HPLC analysis is performed and calibration curves are generated. The calibration curves are subsequently used to determine the concentration of components extracted from the FO encapsulated yeast cells. The primary component of FO was determined to be trans-anethole at 95%+. The HPLC analysis suggests that the encapsulation loading of FO into yeast is between 30-40% by weight. In more recent studies with lyophilized FO-loaded yeast, the final loading was determined.

IV. Larvicidal Trials of Fennel Oil against A. aegypti

The larvicidal bioassays were performed as described in the “Larvicide testing” section of Workman et al., Parasites Vectors (2020) 13:19. Pursuant to these trials, 25 third instar A. aegypti larvae were placed into cups of 100 mL DI water. This was repeated three more times for a total of 100 larvae per trial. A known amount of larvicide was added to each cup. A range of dose concentrations was utilized to generate a killing curve. The control larvae were fed non-viable yeast cells at the highest dose concentration. After 24 hours, the larvae in each cup were counted to determine mortality rates.

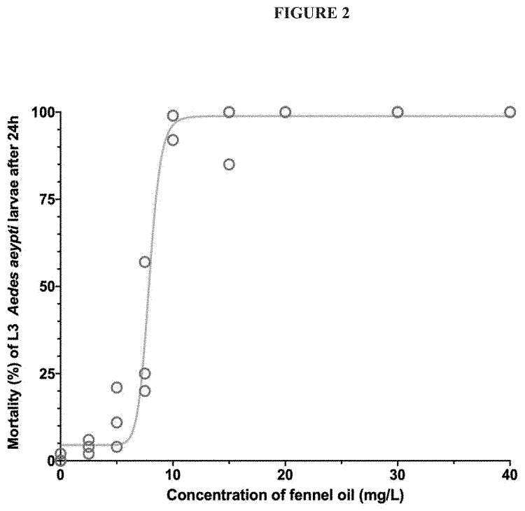

FIG. 2 shows dose dependent killing of third instar A. aegypti larvae by FO. Noteworthy is the extent of mortality of the larvae determined as 8 and 9 mg oil/L for the LD50 and LD90, respectively. These values demonstrated the unexpected activity of the FO against the mosquito larvae.

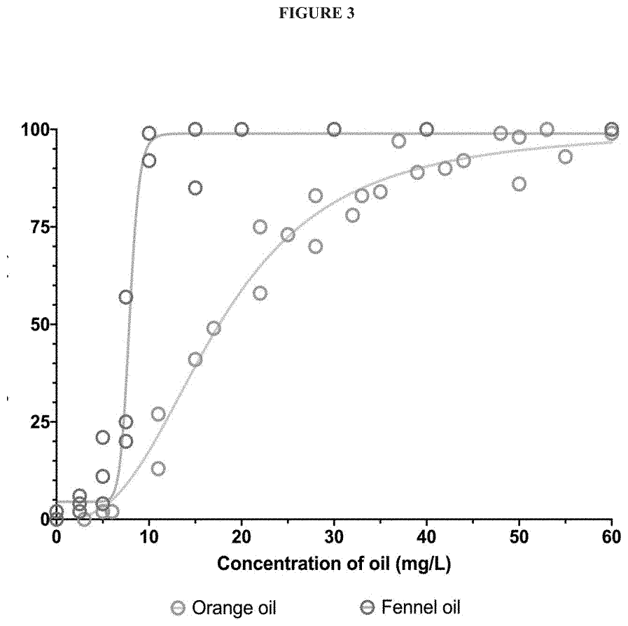

FIG. 3 compares the activity of FO vs. OO as larvicide actives. It can be observed that the A. aegypti larvae are significantly more sensitive to the FO than the OO, making it more ideal for larvicidal application. The unexpected results of FO as a particularly potent larvicide in these experiments would be expected to translate to other larvae, as well. For example, Culex strains (C. quinquefasciatus and C. pipens) are generally known to be less resistant to insecticides than Aedes due to differences in their detoxification enzymes. As such, it would be likely that the FO would also be particularly effective against Culex, in addition to other species.

What is claimed is:

1. A larvicidal capsule comprising an essential oil or essential oil component encapsulated in a non-viable ingestible delivery vehicle, wherein the capsule does not contain any essential oil or primary compounds thereof on the external surface, wherein said essential oil is fennel oil and said non-viable ingestible delivery vehicle is a non-viable yeast cell, said fennel oil being encapsulated in said yeast cell at a concentration effective as a larvicide.

2. The larvicidal capsule of claim 1 wherein the capsule has been washed with a surfactant to remove any residual oil.

3. The larvicidal capsule of claim 1 wherein the essential oil is a mixture of fennel oil of at least 50% of the mixture of essential oils and at least one additional essential oil.

4. The larvicidal capsule of claim 1 further comprising a buoyancy control mechanism.

5. The larvicidal capsule of claim 4 wherein the buoyancy control mechanism comprises an air pocket within the non-viable yeast cell.

6. The larvicidal capsule of claim 5 wherein the air pocket maintains the larvicidal capsule on the surface of the body of water.

7. The larvicidal capsule of claim 5 wherein the air pocket maintains the larvicidal capsule below the surface of the body of water but above the bottom of the body of water.

8. The larvicidal capsule of claim 1 further comprising an adhesive element that facilitates clumping of multiple larvicidal capsules.

9. The larvicidal capsule of claim 8 wherein the adhesive element is applied to the exterior of the ingestible delivery vehicle.

10. The larvicidal capsule of claim 6 further comprising an adhesive element that facilitates clumping of multiple larvicidal capsules.

11. The larvicidal capsule of claim 1 further comprising a soluble coating.

12. A composition comprising a population of larvicide capsules according to claim 1.

13. A method for forming a larvicidal capsule comprising encapsulating an essential oil within a non-viable ingestible delivery vehicle and removing any residual oil on the surface of the larvicidal capsule, wherein the essential oil is fennel oil or a mixture of fennel oil and at least one additional essential oil.

14. The method of claim 13 wherein removing any residual oil from the surface of the larvicidal capsule comprises washing the non-viable ingestible delivery vehicle with a surfactant after encapsulation to remove any residual oil.

15. The method of claim 14 wherein the ingestible delivery vehicle is a non-viable yeast cell.

16. The method of claim 13 wherein said additional essential oil is selected from the group comprising of fennel oil or a combination of fennel oil and a minimum of one additional essential oil or primary compound thereof.

17. The method of claim 13 comprising introducing a buoyancy control mechanism into the larvicidal capsule.

18. The method of claim 14 further comprising coating the ingestible delivery vehicle with a soluble coating.

19. A method for controlling a target pest population comprising;
providing a larvicidal capsule comprising an essential oil or component thereof encapsulated within an ingestible delivery vehicle wherein the capsule does not contain any essential oil or primary compounds thereof on the external surface, wherein said essential oil is fennel oil and said component is trans-anethole;
introducing to the target pest population, the larvicidal capsule under suitable conditions that it is likely that larvae of target pest population will ingest the larvicidal capsule.

20. The method of claim 19 wherein said introducing step comprises positioning a powder comprising the larvicidal capsules in an area wherein gravid adult female target pests are likely to congregate, wherein the powder adheres to the gravid female such that it is carried to oviposition sites.

21. A larvicidal capsule comprising fennel oil or trans-anethole encapsulated in a non-viable ingestible delivery vehicle.

22. The larvicidal capsule of claim 21 wherein the non-viable ingestible delivery vehicle is a non-viable yeast cells.
